(19) United States
(12) Patent Application Publication
(10) Pub. No.: US 2008/0082487 A1
(43) Pub. Date: Apr. 3, 2008

(54) PROCESS AND APPARATUS FOR MANAGING REQUESTS FOR SERVICE

(76) Inventors: Matthew J. Bangel, Poughkeepsie, NY (US); Adam P. Brennand, Worthing (GB); Amy S. Heard, Hilsea (GB); Scott D. Hicks, Underhill Center, VT (US); James A. Martin, Endicott, NY (US); Megan Morrison-Chapman, Waterlooville (GB); Sunita Sharma, Petersfield (GB)

Correspondence Address: HOFFMAN, WARNICK & D'ALESSANDRO LLC, 75 STATE ST, 14TH FLOOR, ALBANY, NY, 12207, US

(21) Appl. No.: 11/536,092

(22) Filed: Sep. 28, 2006

(51) Int. Cl. G06F 17/30

(52) U.S. Cl. 707/3

(57) ABSTRACT

The present invention provides a process and apparatus for managing requests for service. A process for managing requests for service in accordance with an embodiment of the present invention includes: receiving a request for service (RFS) from a customer; designing a solution for the RFS; developing a proposal for the solution for the customer; reviewing and accepting the proposal; implementing the solution; approving the implementation of the solution; and completing the RFS process; wherein the RFS process further comprises: setting at least one key control point (KCP) in each of the above-listed steps; outputting a key control indicator (KCI) for at least one of the KCPs; and performing process control validation testing for at least one of the KCPs.

### FIELD OF THE INVENTION

The present invention relates to a workflow tool, and more specifically relates to a process and apparatus for managing requests for service.

### BACKGROUND OF THE INVENTION

A customer (e.g., a first company) will often approach a provider (e.g., a second company) with a request for service (RFS) to provide a new/updated application, product, or service, or to provide a solution to a problem. Unfortunately, existing RFS process flows are not capable of satisfying the following requirements:

a) Logical and efficient workflow;
b) Expedited processing;
c) Contract changes;
d) Timely communications;
e) Visibility to progress;
f) Accurate measurements and reporting;
g) Security;
h) Complex processes and integrated sub-processes;
i) Configurability;
j) Flexibility;
k) Approval by proxy; and
l) Dynamic tracking to service level agreement (SLA) factoring in periods in an On Hold state.

Accordingly, there is a need for a RFS process flow that addresses these and other requirements.

### SUMMARY OF THE INVENTION

The present invention relates to a process and apparatus for managing requests for service.

A first aspect of the present invention is directed to a process for managing requests for service, comprising: receiving a request for service (RFS) from a customer; designing a solution for the RFS; developing a proposal for the solution for the customer; reviewing and accepting the proposal; implementing the solution; approving the implementation of the solution; and completing the RFS process; wherein the process further comprises: setting at least one key control point (KCP) in each of the above-listed steps; outputting a key control indicator (KCI) for at least one of the KCPs; and performing process control validation testing for at least one of the KCPs.

A second aspect of the present invention is directed to a system for managing requests for service, comprising: a system for setting at least one key control point (KCP) in each of a plurality of steps of a request for service (RFS) process; a system for outputting a key control indicator (KCI) for at least one of the KCPs; and a system for performing process control validation testing for at least one of the KCPs.

A third aspect of the present invention is directed to a process for managing requests for service, comprising: setting at least one key control point (KCP) in each of a plurality of steps of a request for service (RFS) process; outputting a key control indicator (KCI) for at least one of the KCPs; and performing process control validation testing for at least one of the KCPs.

A fourth aspect of the present invention is directed to a program product stored on a computer readable medium for managing requests for service, the computer readable medium comprising program code for: setting at least one key control point (KCP) in each of a plurality of steps of a request for service (RFS) process; outputting a key control indicator (KCI) for at least one of the KCPs; and performing process control validation testing for at least one of the KCPs.

A fifth aspect of the present invention is directed to a method for deploying an application for managing requests for service, comprising: providing a computer infrastructure being operable to: set at least one key control point (KCP) in each of a plurality of steps of a request for service (RFS) process; output a key control indicator (KCI) for at least one of the KCPs; and perform process control validation testing for at least one of the KCPs.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts a high-level flow diagram of an illustrative process for managing requests for service in accordance with an embodiment of the present invention.

FIGS. 2-8 depict each of the steps of the high-level flow diagram of FIG. 1 in greater detail.

FIG. 9 depicts an illustrative computer system for implementing embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

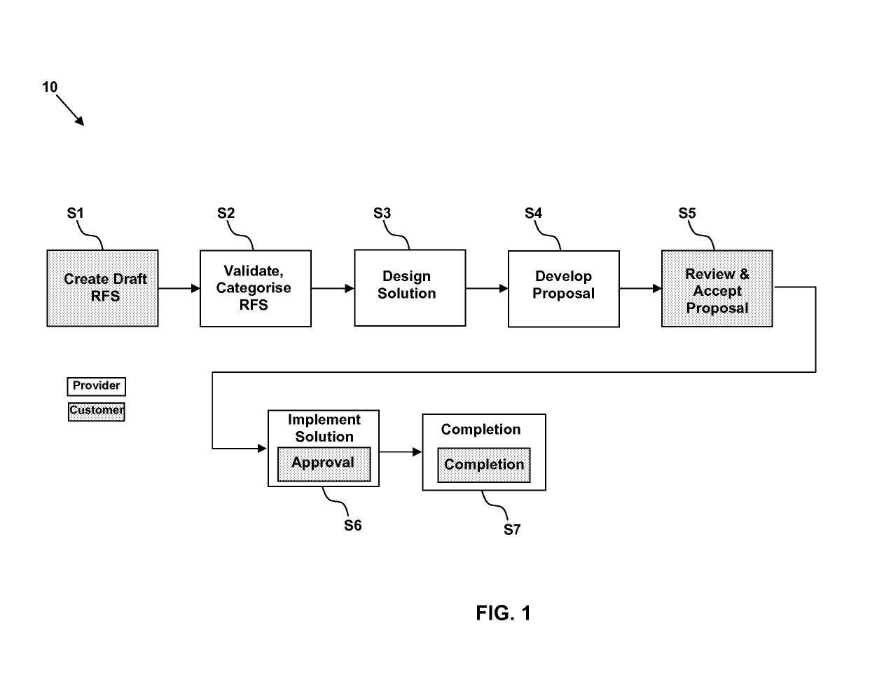

FIG. 1 depicts a high-level flow diagram 10 of an illustrative process for managing requests for service in accordance with an embodiment of the present invention. In step S1, a customer creates a draft request for service (RFS) and submits the RFS to a provider. In step S2, the provider validates and categorizes the RFS. In step S3, the provider designs a solution for the RFS. In step S4, the provider develops a proposal for the solution and submits the proposal to the customer. In step S5, the customer reviews and accepts the proposal. In step S6, the provider implements the solution and the customer approves the implementation of the solution. Finally, in step S7, the provider and the customer complete the RFS process. Each of steps S1-S7 will be described in greater detail below.

In the following description, the following definitions are adhered to:

a) Key Control Point (KCP)—A key control point (KCP) is a position in the process at which an action must be completed in order to ensure the integrity of the process. A KCP requires an associated action be performed completely, accurately, with authorization, and within agreed timeframes, before the process can proceed further. KCPs are managed on an ongoing basis.
b) Key Control Indicator—A key control indicator (KCI), in the form of a report, is used to help gauge the effectiveness of the control mechanisms (including KCPs). KCIs determine whether control mechanisms are operating as designed. KCIs are captured and managed throughout the process by management reports which indicate that further action is required to move them to the next stage. These reports help the process owner identify exceptions or unexpected time lags in the process.
c) Process Control Validation—Validation testing to determine whether control mechanisms (including KCPs) are operating as designed, which includes inspection of transactions and activities at KCPs. This enables the process owner to perform validation testing on an ongoing basis.

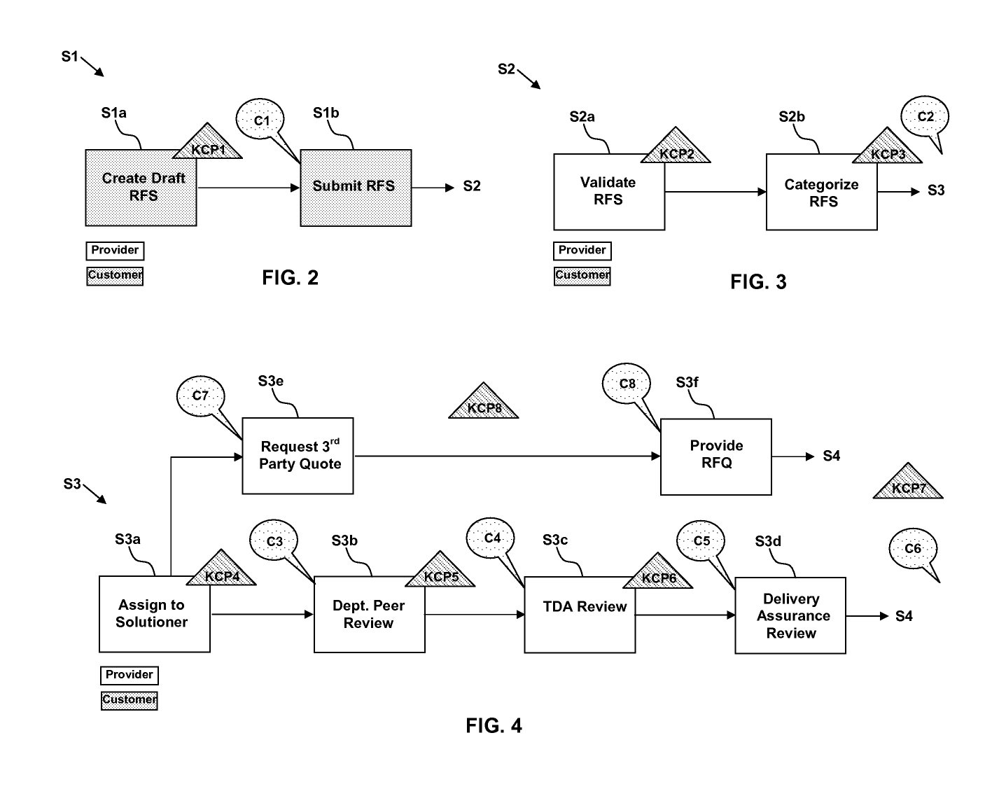

Step S1 of FIG. 1 is depicted in greater detail in FIG. 2. Step S1 includes a step S1a, in which a draft RFS is created by the customer, and a step S1b, in which the customer submits the RFS to the provider. Step S1 further includes a key control point KCP1 as described in the following table:

| Key Control | Key Control | Process Control |
|---|---|---|
| Point (KCP) | Indicator (KCI) | Validation Testing |
| KCP1 - Submit RFS | RFS in draft | Verify that all mandatory |
| | | information has been provided |

The KCI associated with KCP1 indicates that the RFS is in draft form. The associated process control validation testing verifies that all mandatory information has been provided in the RFS.

Step S1 also includes a communicate requirement C1 as described in the following table:

| | | To Whom |
|---|---|---|
| Communicate | How | (e.g., Dept. or Person) |
| C1 - Submit RFS | Automatic, standard | Customer Project Manager |
| | communication | |

To this extent, the RFS is automatically communicated to a project manager (PM) of the customer (or other appropriate individual(s)), for approval and submission to the provider. Communication can be provided in any suitable manner (e.g., via email, intranet, hardcopy, etc).

Step S2 of FIG. 1 is depicted in greater detail in FIG. 3. Step S2 includes a step S2a, in which the RFS received by the provider is validated, and a step S2b, in which the RFS is categorized. Step S2 further includes key control points KCP2 and KCP3 as described in the following table:

| | Key Control | Process Control |
|---|---|---|
| Key Control Point (KCP) | Indicator (KCI) | Validation Testing |
| KCP2 - Validate RFS | RFS in Initiation/ | Verify that forms have |
| | Under Review | been properly prepared |
| | RFS in Initiation/ | |
| | Returned | |
| KCP3 - Categorize RFS | | Verify that all mandatory |
| | | information has been |
| | | provided |

The KCIs associated with KCP2 indicate that the RFS is in initiation and under review or is in initiation and has been returned. The associated process control validation testing verifies that all forms associated with the RFS have been properly prepared. The process control validation testing associated with KCP3 verifies that all mandatory information has been provided. Note that a KCP (e.g., KCP3) need not have an associated KCI. Further, a KCP (e.g., KCP2) can have a plurality of KCIs.

Step S2 also includes a communicate requirement C2 as described in the following table:

| | | To Whom |
|---|---|---|
| Communicate | How | (e.g., Dept. or Person) |
| C2 - Categorize RFS | Automatic, standard | Customer PM |
| | communication | Provider contact |
| | | Others (if necessary) |

### In this case, the categorization of the RFS is automatically communicated to a customer PM, a provider contact, and other necessary person(s), if any.

Step S3 of FIG. 1 is depicted in greater detail in FIG. 4. Step S3 includes a step S3a, in which the RFS is assigned to a solutioner, a step S3b, in which a solution for the RFS is submitted for department peer review, a step S3c, in which the solution is submitted for technical design authority (TDA) review, and a step S3d, in which the solution is submitted for delivery assurance review. Step S3 can also include a step S3e, in which a request for quote (RFQ) is submitted to a third party to develop a part/all of the solution, and a step S3f, in which the RFQ is provided by the third party to the provider. Multiple RFQs can be submitted to one or more third parties.

Step S3 further includes key control points KCP4-KCP7, and possibly KCP8, as described in the following table:

| Key Control Point (KCP) | Key Control Indicator (KCI) | Process Control Validation Testing |
|---|---|---|
| KCP4 - Dept. peer review | RFS solution ready for | Assign to a named individual |
| | department peer review | Verify technical information |
| | | Peer review of technical & 3^{rd} party |
| | | solution |
| KCP5 - TDA review | RFS solution ready for TDA | Assign to a named individual |
| | Review | Verify that peer review has been |
| | | completed |
| | | TDA review of technical & 3^{rd} party |
| | | solution |
| KCP6 - Delivery assurance | RFS solution ready for | Verify that TDA review has been |
| review | delivery assurance review | completed |
| | | Verify solution quality |
| KCP7 - Proposal | RFS solution in proposal | Verify that all technical reviews have |
| Development | development | been completed |
| | | Verify that RFQ has been provided (if |
| | | necessary) |
| KCP8 - RFQ | RFS in Solution Design/Work | Verify that correct information has |
| | in Progress | been provided |
| | RFS awaiting 3^{rd} party quote | |
| | RFS RFQ provided | |

The KCI associated with KCP4 indicates that the RFS solution is ready for department peer review. The associated process control validation testing submits the solution to a named individual who is responsible for managing the department peer review, verifies the technical information in the solution, and provides a peer review of the technical and any 3^{rd} party solution.

The KCI associated with KCP5 indicates that the RFS solution is ready for TDA review. The associated process control validation testing submits the solution to a named individual who is responsible for managing the TDA review, verifies that the peer review has been completed, and provides a TDA review of the technical and any 3^{rd} party solution.

The KCI associated with KCP6 indicates that the RFS solution is ready for delivery assurance review. The associated process control validation testing verifies that the TDA review has been completed, and verifies the quality of the solution.

The KCI associated with KCP7 indicates that the RFS solution is in proposal development. The associated process control validation testing verifies that all technical reviews have been completed, and that a RFQ from a 3^{rd} party (if necessary) has been provided. The latter requirement corresponds to KCP8 RFQ. Specifically, the KCIs associated with KCP8 indicate that: the RFS is in Solution Design/Work in Progress; the RFS is awaiting a 3rd party quote; and the RFQ has been provided. The associated process control validation testing verifies that correct information has been provided.

Step S3 also includes several communicate requirements C3-C6, and possibly C7-C8, as described in the following table:

| | | To Whom |
|---|---|---|
| Communicate | How | (e.g., Dept. or Person) |
| C3 - Ready for dept. peer | Automatic, standard | Named individual |
| review | communication | |
| C4 - Ready for TDA review | Automatic, standard | Named individual |
| | communication | |
| C5 - Ready for delivery | Automatic, standard | Delivery Assurance |
| assurance review | communication | contact |
| C6 - Ready for project | Automatic, standard | Provider project |
| manager review | communication | manager (PM) |
| C7 - Request RFQ | Automatic, standard | 3^{rd} party contact |
| | communication | |
| C8 - RFQ provided | Automatic, standard | Provider contact |
| | communication | |

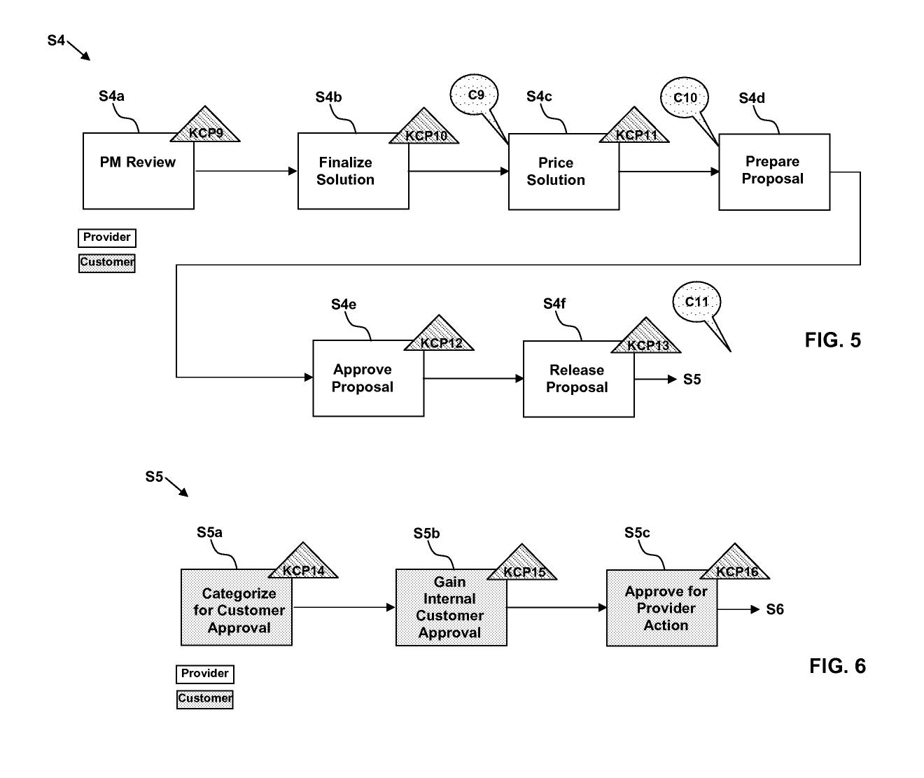

Step S4 of FIG. 1 is depicted in greater detail in FIG. 5. Step S4 includes a step S4a, in which the proposed solution is submitted to a provider project manager (PM) for review, a step S4b, in which the solution is finalized, a step S4c, in which pricing of the solution is provided, a step S4d, in which a proposal for the solution is prepared, a step S4e, in which proposal is approved, and a step S4f, in which the proposal is released to the customer.

Step S4 further includes key control points KCP9-KCP13 as described in the following table:

| Key Control Point (KCP) | Key Control Indicator (KCI) | Process Control Validation Testing |
|---|---|---|
| KCP9 - Ready for PM Review | Proposal ready for PM | Verify that correct information has |
| | review | been provided |
| KCP10 - Finalize Solution | | Verify that correct information has |
| | | been provided and finalize updates as |
| | | necessary |
| | | Finance & Planning (F & P) pricing |
| | | required? |
| KCP11 - Price Solution | Solution requiring F & P | Verify that all approvals have been |
| | pricing | provided |
| | | Verify that all correct information has |
| | | been provided |
| KCP12 - Approve Proposal | Proposal awaiting | Verify that pricing has been provided |
| | Contracts & Negotiations | Verify that the proposal has been |
| | (C & N) approval | properly prepared |
| KCP13 - Release Proposal | Proposal awaiting final | Verify that C & N approval has been |
| | provider approval & release | obtained |
| | | Option to select approval level |

The KCI associated with KCP9 indicates that the proposed solution is ready for review by the provider PM. The associated process control validation testing verifies that the correct information has been provided.

The process control validation testing associated with KCP10 verifies that correct information has been provided. Further, it determines if Finance & Planning (F & P) pricing is required. If not, flow step S4c is skipped.

The KCI associated with KCP11 indicates that the solution for the RFS requires F & P pricing. The associated process control validation testing verifies that all approvals have been provided and that all correct information has been provided

The KCI associated with KCP12 indicates that the proposal is awaiting Contracts & Negotiations (C & N) approval. The associated process control validation testing verifies that pricing has been provided and verifies that the proposal has been properly prepared.

The KCI associated with KCP13 indicates that the proposal is awaiting final provider approval and release. The associated process control validation testing verifies that C & N approval has been obtained and provides an option to select approval level.

Step S4 also includes several communicate requirements C9-C11 as described in the following table:

| | | To Whom |
|---|---|---|
| Communicate | How | (e.g., Dept. or Person) |
| C9 - Price solution | Automatic, standard | F & P |
| | communication | |
| C10 - Approve solution | Automatic, standard | C & N |
| | communication | |
| C11 - Release proposal | Automatic, standard | Customer PM |
| | communication | |

Step S5 of FIG. 1 is depicted in greater detail in FIG. 6. Step S5 includes a step S5a, in which the proposal is categorized for approval by the customer, a step S5b, in which internal customer approval is gained, and a step S5c, in which the customer approves action by the provider regarding the proposed solution.

Step S5 further includes key control points KCP14-KCP16 as described in the following table:

| Key Control Point (KCP) | Key Control Indicator (KCI) | Process Control Validation Testing |
|---|---|---|
| KCP14 - Categorize for | Proposal awaiting customer | Verify proposal content |
| customer approval | approval | Option to select approval level |
| KCP15 - Gain customer | Proposal awaiting customer | Verify that all customer approvals |
| approval | approval | have been obtained |
| KCP16 - Approve for provider | Proposal awaiting final | Verify that all customer approvals and |
| action | customer approval | associated evidence have been |
| | | obtained |
| | | Verify that all mandatory information |
| | | is present and correct |

The KCI associated with KCP14 indicates that the proposed solution is awaiting customer approval. The associated process control validation testing verifies the content of the proposal and provides an option to select approval level.

The KCI associated with KCP15 indicates that the proposal is awaiting customer approval. The associated process control validation testing verifies that all customer approvals have been obtained.

The KCI associated with KCP16 indicates that the proposal is awaiting final customer approval. The associated process control validation testing verifies that all customer approvals and associated evidence have been obtained, and that all mandatory information is present and correct.

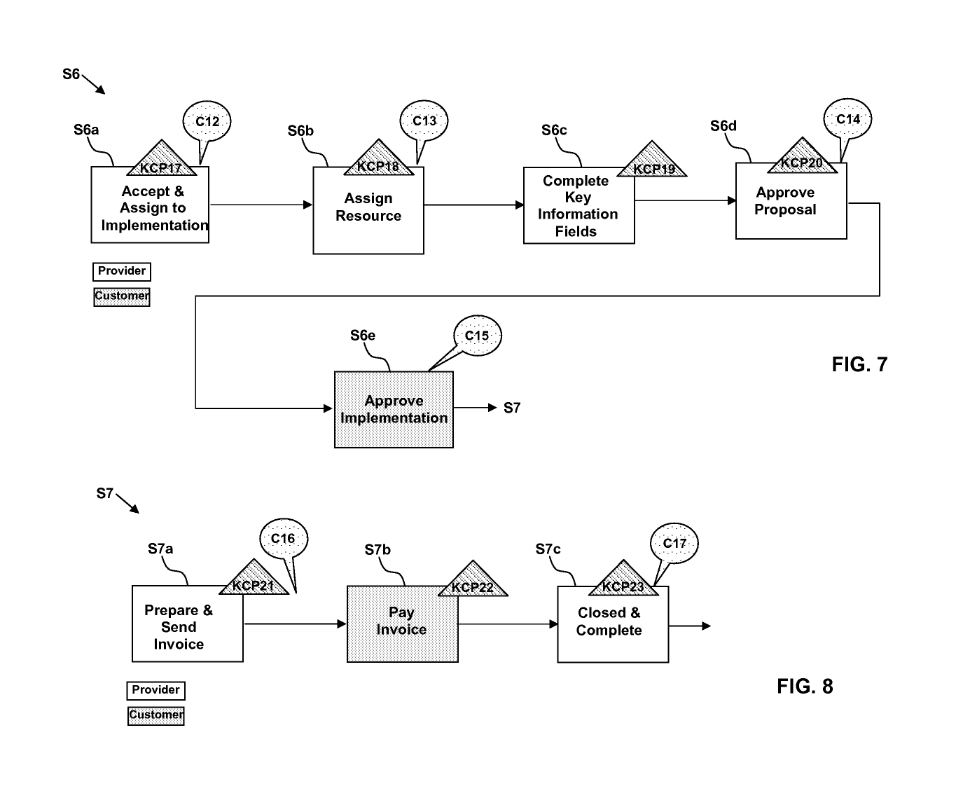

Step S6 of FIG. 1 is depicted in greater detail in FIG. 7. Step S6 includes a step S6a, in which the customer approved solution is accepted by the provider and is assigned to implementation. Step S6 further includes a step S6b, in which the resources required to implement the solution are assigned, a step S6c, in which all key tracking fields for the implementation of the solution are completed, a step S6d, in which the solution is implemented by the provider, and a step S6e, in which the solution implemented by the provider is approved by the customer.

Step S6 includes key control points KCP17-KCP20 as described in the following table:

| Key Control Point (KCP) | Key Control Indicator (KCI) | Process Control Validation Testing |
|---|---|---|
| KCP17 - Accept & assign to | Proposal approved by | Verify proposal content & correct approvals |
| implementation | customer | |
| KCP18 - Assign resource | All projects for solution in | Verify and update appropriate tracking fields |
| | implementation - open or | |
| | awaiting resource | |
| KCP19 - Implementation | All projects for solution in | Verify and update appropriate tracking fields |
| | implementation - by status | |
| KCP20 - Completion | All projects for solution in | Verify that all mandatory fields and |
| | implementation or | approvals have been gained (including |
| | implemented | delivery assurance) |
| | | Verify and update appropriate tracking fields |

The KCI associated with KCP17 indicates that the proposal has been accepted by the customer. The associated process control validation testing verifies the content of the proposal and the correctness of the approvals.

The KCI associated with KCP18 indicates the status (e.g., open or awaiting resource) of the projects associated with the implementation of the solution. The associated process control validation testing verifies and updates the appropriate tracking fields for the projects.

The KCI associated with KCP19 indicates the status (e.g., in progress, implemented, completed, closed, cancelled, or on-hold) of the projects associated with the implementation of the solution. The associated process control validation testing verifies and updates the appropriate tracking fields for the projects.

The KCI associated with KCP20 indicates that all projects associated with the solution are in implementation or have been implemented. The associated process control validation testing verifies that all mandatory fields and approvals have been obtained (including delivery assurance) and verifies and updates the appropriate tracking fields for the projects.

Step S6 also includes several communicate requirements C12-C15 as described in the following table:

| | | To Whom |
|---|---|---|
| Communicate | How | (e.g., Dept. or Person) |
| C12 - Accept & assign to | Automatic, standard | Customer PM |
| provider implementation | communication | Provider contact |
| | | Others (if necessary) |
| C13 - Assign resource | Automatic, standard | Customer PM |
| | communication | Provider contact |
| | | Others (if necessary) |
| C14 - Implementation | Automatic, standard | Customer PM |
| complete | communication | Others (if necessary) |
| C15 - Customer approval of | Automatic, standard | Provider PM |
| implementation | communication | Customer F & P |

Step S7 of FIG. 1 is depicted in greater detail in FIG. 8. Step S7 includes a step S7a, in which the provider prepares and sends an invoice for the implemented solution to the customer, a step S7b, in which the customer pays the invoice, and a step S7c, in which the RFS process is closed and completed.

Step S7 includes key control points KCP21-KCP23 as described in the following table:

| | Key Control | Process Control |
|---|---|---|
| Key Control Point (KCP) | Indicator (KCI) | Validation Testing |
| KCP21 - Prepare & send | Proposal ready | Verify that all approvals |
| final invoice | for final invoice | have been obtained |
| KCP22 - Pay final invoice | Final invoice sent | |
| KCP23 - Closed/complete | Final invoice paid | Verify that payment |
| | | has been received |

The KCI associated with KCP21 indicates that the proposal is ready for final invoice. The associated process control validation testing verifies that all approvals have been obtained.

The KCI associated with KCP22 indicates the final invoice has been sent.

The KCI associated with KCP23 indicates the final invoice has been paid. The associated process control validation testing verifies that payment for the final invoice has been received.

Step S7 also includes several communicate requirements C12-C15 as described in the following table:

| | | To Whom |
|---|---|---|
| Communicate | How | (e.g., Dept. or Person) |
| C16 - Invoice sent | Automatic, standard | Customer PM |
| | communication | |
| C17 - Invoice paid | Automatic, standard | Provider contact |
| | communication | |

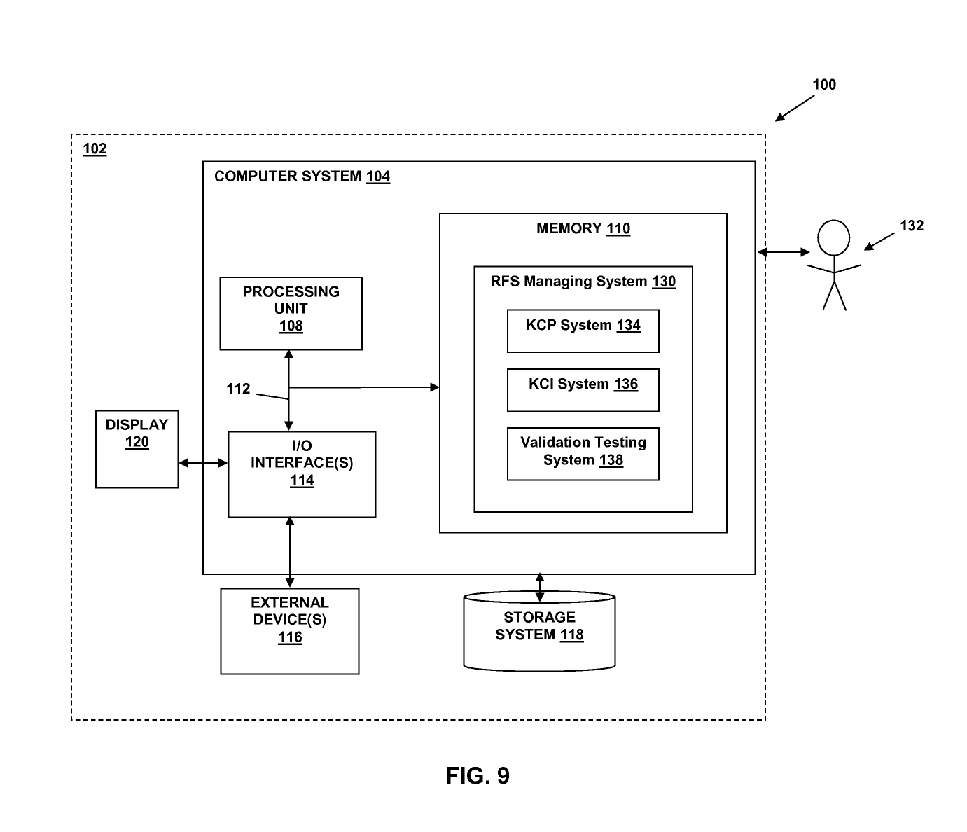

FIG. 9 depicts an illustrative system 100 for managing requests for service in accordance with embodiment(s) of the present invention. The system 100 includes a computer infrastructure 102 that can perform the various process steps described herein. The computer infrastructure 102 is shown including a computer system 104.

The computer system 104 is shown as including a processing unit 108, a memory 110, at least one input/output (I/O) interface 114, and a bus 112. Further, the computer system 104 is shown in communication with at least one external device 116 and a storage system 118. In general, the processing unit 108 executes computer program code, that is stored in memory 110 and/or storage system 118. While executing computer program code, the processing unit 108 can read and/or write data from/to the memory 110, storage system 118, and/or I/O interface(s) 114. Bus 112 provides a communication link between each of the components in the computer system 104. The external device(s) 116 can comprise any device (e.g., display 120) that enables a user to interact with the computer system 104 or any device that enables the computer system 104 to communicate with one or more other computer systems. The program code includes an RFS managing system 130 for managing requests for service from a customer 132 as described in detail above with reference to FIGS. 1-8. The RFS managing system 130 includes a KCP system 134 for setting at least one KCP in each of a plurality of steps of a RFS process, a KCI system 136 for outputting a KCI for at least one of the KCPs, and a validation testing system 138 for performing process control validation testing for at least one of the KCPs.

The computer system 104 can comprise any general purpose computing article of manufacture capable of executing computer program code installed by a user (e.g., a personal computer, server, handheld device, etc.). However, it is understood that the computer system 104 is only representative of various possible computer systems that may perform the various process steps of the invention. To this extent, in other embodiments, the computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, the computer infrastructure 102 is only illustrative of various types of computer infrastructures that can be used to implement the present invention. For example, in one embodiment, the computer infrastructure 102 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

It is understood that some of the various systems shown in FIG. 9 can be implemented independently, combined, and/or stored in memory for one or more separate computer systems that communicate over a network. Further, it is understood that some of the systems and/or functionality may not be implemented, or additional systems and/or functionality may be included as part of the system 100.

It is understood that the invention further provides various alternative embodiments. For example, in one embodiment, the invention provides a computer-readable medium that includes computer program code to enable a computer infrastructure to carry out and/or implement the various process steps of the present invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as the memory 110 and/or storage system 118 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. A service provider can create, maintain, support, etc., a computer infrastructure, such as the computer infrastructure 102, that performs the process steps of the invention for one or more customers. In return, the service provider can receive payment from the customer(s) under a subscription and/or fee agreement and/or the service provider can receive payment from the sale of advertising space to one or more third parties.

In still another embodiment, a computer infrastructure, such as the computer infrastructure 102, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as the computer system 104, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. The program code can be embodied as one or more types of program products, such as an application/software program, component software/a library of functions, an operating system, a basic I/O system/driver for a particular computing and/or I/O device, and the like.

The foregoing description of the preferred embodiments of this invention has been presented for purposes of illustration and description. It is not intended to be exhaustive or to limit the invention to the precise form disclosed, and obviously, many modifications and variations are possible.

What is claimed is:

1. A process for managing requests for service, comprising:
receiving a request for service (RFS) from a customer;
designing a solution for the RFS;
developing a proposal for the solution for the customer;
reviewing and accepting the proposal;
implementing the solution;
approving the implementation of the solution; and
completing the RFS process;
wherein the RFS process further comprises:
setting at least one key control point (KCP) in each of the above-listed steps;
outputting a key control indicator (KCI) for at least one of the KCPs; and
performing process control validation testing for at least one of the KCPs.

2. The process of claim 1, wherein a KCP comprises a point in the RFS process at which an action must be completed, before the RFS process can proceed further.

3. The process of claim 2, wherein the action must be performed completely, accurately, with authorization, and within a given timeframe.

4. The process of claim 1, wherein a KCI comprises a report.

5. The process of claim 1, wherein performing process control validation testing for at least one of the KCPs is selected from the group consisting of: verifying that all required information has been provided, verifying that all provided information is correct, verifying that all forms have been properly prepared, verifying technical information for the solution, verifying that at least one technical review of the solution has been performed, verifying a quality of the solution, verifying that all approvals have been provided, verifying that the proposal has been properly prepared, and verifying that payment has been received.

6. The process of claim 1, wherein at least one of the steps includes a communicate requirement.

7. The process of claim 6, wherein communication is automatically provided.

8. A system for managing requests for service, comprising:
a system for setting at least one key control point (KCP) in each of a plurality of steps of a request for service (RFS) process;
a system for outputting a key control indicator (KCI) for at least one of the KCPs; and
a system for performing process control validation testing for at least one of the KCPs.

9. The system of claim 8, wherein the RFS process comprises:
receiving a RFS from a customer;
designing a solution for the RFS;
developing a proposal for the solution for the customer;
reviewing and accepting the proposal;
implementing the solution;
approving the implementation of the solution; and
completing the RFS process.

10. The system of claim 8, wherein a KCP comprises a point in the RFS process at which an action must be completed, before the RFS process can proceed further.

11. The system of claim 10, wherein the action must be performed completely, accurately, with authorization, and within a given timeframe.

12. The system of claim 8, wherein a KCI comprises a report.

13. The system of claim 8, wherein the system for performing process control validation testing for at least one of the KCPs is configured to perform a step selected from the group consisting of: verifying that all required information has been provided, verifying that all provided information is correct, verifying that all forms have been properly prepared, verifying technical information for the solution, verifying that at least one technical review of the solution has been performed, verifying a quality of the solution, verifying that all approvals have been provided, verifying that the proposal has been properly prepared, and verifying that payment has been received.

14. The system of claim 8, further comprising a system for providing communication during the RFS process.

15. A process for managing requests for service, comprising:
setting at least one key control point (KCP) in each of a plurality of steps of a request for service (RFS) process;
outputting a key control indicator (KCI) for at least one of the KCPs; and
performing process control validation testing for at least one of the KCPs.

16. The process of claim 15, wherein a KCP comprises a point in the RFS process at which an action must be completed, before the RFS process can proceed further.

17. The process of claim 16, wherein the action must be performed completely, accurately, with authorization, and within a given timeframe.

18. The process of claim 15, wherein a KCI comprises a report.

19. The process of claim 15, wherein performing process control validation testing for at least one of the KCPs is selected from the group consisting of: verifying that all required information has been provided, verifying that all provided information is correct, verifying that all forms have been properly prepared, verifying technical information for the solution, verifying that at least one technical review of the solution has been performed, verifying a quality of the solution, verifying that all approvals have been provided, verifying that the proposal has been properly prepared, and verifying that payment has been received.

20. The process of claim 15, wherein at least one of the steps includes a communicate requirement.

21. The process of claim 20, wherein communication is automatically provided.

22. A program product stored on a computer readable medium for managing requests for service, the computer readable medium comprising program code for:
setting at least one key control point (KCP) in each of a plurality of steps of a request for service (RFS) process;
outputting a key control indicator (KCI) for at least one of the KCPs; and
performing process control validation testing for at least one of the KCPs.
